(19) United States
(12) Patent Application Publication
(10) Pub. No.: US 2012/0078530 A1
(43) Pub. Date: Mar. 29, 2012

(54) METHOD FOR DETERMINING RECEPTOR-LIGAND PAIRS

(76) Inventors: Steven C. Almo, Pelham, NY (US); Andras Fiser, Astoria, NY (US); Rotem Rubinstein, Jackson Heights, NY (US)

(21) Appl. No.: 13/085,081

(22) Filed: Apr. 12, 2011

Related U.S. Application Data
(60) Provisional application No. 61/342,339, filed on Apr. 13, 2010.

(51) Int. Cl. G06F 19/20; G06F 19/22

(52) U.S. Cl. 702/20

(57) ABSTRACT

The present invention provides a method of determining related proteins, the method comprising obtaining sequences of interest, wherein the sequences are amino acid sequences for proteins or nucleotide sequences encoding proteins; comparing segments of each sequence of interest with a database of amino acid or nucleotide sequences; generating a profile for each sequence of interest comprising a list of all sequences from the database of sequences that have segments corresponding to the segments of each sequence of interest; and comparing the database sequences appearing in the profile of each sequence of interest to the database sequences appearing in the profile of every other sequence of interest, wherein similar profiles indicate that the sequences of interest correspond to related proteins while dissimilar profiles indicate that the sequences of interest do not correspond to related proteins, wherein profiles are similar if there is at least a 30% overlap between the database sequences appearing in the profiles of the sequences of interest.

### CROSS-REFERENCE TO RELATED APPLICATIONS

This application claims benefit of U.S. Provisional Application No. 61/342,339 filed Apr. 13, 2010, the contents of which are hereby incorporated by reference.

### STATEMENT OF GOVERNMENT SUPPORT

This invention was made with government support under grant numbers U54GM62529 and RO1AI07289 awarded by the National Institutes of Health, U.S. Department of Health and Human Services. The government has certain rights in the invention.

### FIELD OF THE INVENTION

The present invention relates generally to the field of protein-based therapeutics, more specifically, receptor-ligand pairs, and identifying related proteins.

### BACKGROUND OF THE INVENTION

Throughout this application various publications are referred to in parenthesis. Full citations for these references may be found at the end of the specification. The disclosures of these publications are hereby incorporated by reference in their entirety into the subject application to more fully describe the art to which the subject invention pertains.

Protein-based therapeutics, typically in the form of soluble Ig-fusion proteins are among the most powerful approaches for treating a wide range of human diseases. Classic examples include Orencia® (CTLA-4-Ig fusion protein marketed by BMS) and Enbrel® (TNFR-Ig fusion protein marketed by Amgen and Wyeth) for the treatment of a wide range of autoimmune diseases, including rheumatoid arthritis. As soluble versions of cell surface presented receptors, these reagents function by binding to their cognate ligands (B7 and TNF for CTLA-4 and TNFR, respectively) and specifically blocking the associated signaling pathways, resulting in profound therapeutic modulation of the patient's immune system. The major premise underlying these and other protein-based therapeutics is the knowledge of the specific receptor-ligands pairs that are being targeted. This requirement also represents a major challenge, as a large number of potent immune-modulatory molecules have been described, but their cognate counter-receptors remain unknown.

The ability to identify new targets for the development of protein-based therapeutics represents one of the major challenges facing academics, clinicians and industry. The realization of this goal requires the identification of cognate receptor-ligand pairs; however, for a large number of bioactive cell surface and secreted proteins the associated co-receptor is not known. Existing computational approaches to define function and to identify cognate receptor-ligand pairs and existing physical proximity approaches to define functionally related clusters of genes are limited.

Existing Computational Approaches. Function has not been assigned to a large fraction of all existing sequences, including cell surface and secreted proteins that are the focus of protein-based therapeutics. A number of computational/informatics approaches are available to define functionally related families of proteins. Examples are the evolutionarily and functionally related subfamilies within the Imunnoglobulin Superfamily (IgSF) (FIG. 1). The members of individual subfamilies share primary amino acid sequence signatures that are responsible for the unique structural characteristics that underlie function. Genome sequencing efforts provide two pieces of information that are useful for the initial identification of such families: (i) physical proximity in the genome and (ii) primary sequence similarity.

Physical proximity. Gene duplication represents one of the major mechanisms for the generation of new function. Frequently, the duplicated genes, or paralogs, are immediately adjacent to one another and sizeable clusters of duplicated genes are found in the genome. Because these genes are evolutionarily related, they share primary sequence signatures that are responsible for similar structural features supporting related biological functions. Detailed sequence differences within these clusters of physically proximal genes point to determinant(s) responsible for specialized structure and function. FIG. 2 highlights several examples of proximal gene clusters in the Ig superfamily, including the CD28, T-cell immunoglobulin mucin domain (TIM), and signaling lymphocyte activation molecule (SLAM) families, as well as various families from the TNF and TNFR superfamilies. The identification of proximally related clusters of genes represents a direct, simple and intuitive strategy for defining protein families, which can be examined for unique primary sequence signatures to identify candidates for structure determination. These clusters provide immediate functional insight as all binding partners of the SLAM and nectin families reside within these same families. Of particular importance, proximity allows for the generation of functionally related subfamilies even when the sequence similarity is very weak (i.e., as low as 15% in the Ig superfamily). However, not all related sequences are physically linked—many are more widely distributed across the genome. Therefore, there is a need for a more general approach to define related families of proteins based solely on primary amino acid sequence.

Existing approaches utilizing simple pair wise sequence alignments, such as BlastClust (1, 2) and the clustering approach of Babbitt (3), result in only relatively modest clustering of functionally related sequences. Additionally, existing approaches are resource intensive and time intensive, relying on experimental screening strategies requiring purification of thousands of proteins. Both substantially greater discrimination between related proteins and enhanced clustering of functionally related proteins are needed to identify new targets for protein-based therapeutics in order to continue to provide new treatment opportunities for myriad diseases.

The exploitation of receptor-ligand interactions is a central tenet of protein-based therapeutics. An in silico method of predicting these interactions, without the need for expensive and time consuming benchtop purification and screening protocols is needed.

The present invention addresses these problems by providing a new approach for identifying candidate receptor-ligand pairs that can be readily subjected to experimental verification and by clustering proteins with shared/related functions, thereby allowing for functional assignments of previously unannotated sequences.

### SUMMARY OF THE INVENTION

The present invention provides a method of determining related proteins, the method comprising obtaining sequences of interest, wherein the sequences are amino acid sequences for proteins or nucleotide sequences encoding proteins; comparing segments of each sequence of interest with a database of amino acid or nucleotide sequences; generating a profile for each sequence of interest comprising a list of all sequences from the database of sequences that have segments corresponding to the segments of each sequence of interest; and comparing the database sequences appearing in the profile of each sequence of interest to the database sequences appearing in the profile of every other sequence of interest, wherein similar profiles indicate that the sequences of interest correspond to related proteins while dissimilar profiles indicate that the sequences of interest do not correspond to related proteins, wherein profiles are similar if there is at least a 30% overlap between the database sequences appearing in the profiles of the sequences of interest.

A method of determining related proteins, the method comprising
obtaining at least a first and a second sequence of interest, wherein at least one sequence is obtained by obtaining and sequencing a sample from a subject, wherein the sequences are amino acid sequences of proteins or are nucleotide sequences encoding proteins;
individually comparing a plurality of segments of the first and second amino acid sequence of interest, or of the first and second nucleotide sequence of interest, with a database of amino acid sequences or nucleotide sequences, respectively;
generating a profile for each sequence of interest, wherein the profile comprises a list of all sequences, from the database of sequences, that have segments having identical sequences to corresponding segments of the sequence of interest; and
comparing the database sequences appearing in the profile of the first sequence of interest to the database sequences appearing in the profile of at least the second sequence of interest, wherein an at least 30% overlap of sequences between the profile of the first sequence of interest and the profile of the second sequence of interest indicates that the first and second sequences of interest are related proteins, while less than 30% overlap of sequences between the profile of the first sequence of interest and the profile of the second sequence of interest indicates that the first and second sequences of interest are not related proteins.

A method for determining if a first protein of interest and a second protein of interest are related comprising:

accessing, using one or more processors, a first set of data from a database, the first set of data being amino acid sequences of a plurality of proteins;

comparing, using one or more processors, a second set of data to the first set of data and comparing, using one or more processors, a third set of data to the first set of data, wherein the second and third set of data are each, respectively, an amino acid sequence of the first protein of interest and an amino acid sequence of the second protein of interest, wherein a plurality of segments of the amino acid sequence of each protein of interest is individually compared to the first set of data;

generating, using one or more processors, a first profile for the first protein of interest and a second profile for the second protein of interest, wherein the first and second profile comprise, respectively, a list of all amino acid sequences from the first set of data that have segments having identical sequences to corresponding segments of the amino acid sequence of the first protein of interest, and a list of all amino acid sequences from the first set of data that have segments having identical sequences to corresponding segments of the amino acid sequence of the second protein of interest;

comparing, using one or more processors, the list of all amino acid sequences appearing in the first profile and the list of all amino acid sequences appearing in the second profile so as to determine the percent overlap between the first profile and the second profile, and storing the fourth set of data thereby produced, wherein an at least 30% overlap of sequences between the first and the second profile indicates that the first and second proteins of interest are related proteins, while less than 30% overlap of sequences between the first and the second profile does not indicate that the first and second proteins of interest are related proteins.

A system for identifying related proteins, comprising:

one or more data processing apparatus; and

a computer-readable medium coupled to the one or more data processing apparatus having instructions stored thereon which, when executed by the one or more data processing apparatus, cause the one or more data processing apparatus to perform a method comprising:

accessing, using one or more processors, a first set of data from a database, the first set of data being amino acid sequences of a plurality of proteins;

comparing, using one or more processors, a second set of data to the first set of data and comparing, using one or more processors, a third set of data to the first set of data, wherein the second and third set of data are each, respectively, an amino acid sequence of the first protein of interest and an amino acid sequence of the second protein of interest, wherein a plurality of segments of the amino acid sequence of each protein of interest is individually compared to the first set of data;

generating, using one or more processors, a first profile for the first protein of interest and a second profile for the second protein of interest, wherein the first and second profile comprise, respectively, a list of all amino acid sequences from the first set of data that have segments having identical sequences to corresponding segments of the amino acid sequence of the first protein of interest, and a list of all amino acid sequences from the first set of data that have segments having identical sequences to corresponding segments of the amino acid sequence of the second protein of interest;

comparing, using one or more processors, the list of all amino acid sequences appearing in the first profile and the list of all amino acid sequences appearing in the second profile so as to determine the percent overlap between the first profile and the second profile, and storing the fourth set of data thereby produced, wherein an at least 30% overlap of sequences between the first and the second profile indicates that the first and second proteins of interest are related proteins, while less than 30% overlap of sequences between the first and the second profile does not indicate that the first and second proteins of interest are related proteins.

A computer-readable medium comprising instructions stored thereon which, when executed by a data processing apparatus, causes the data processing apparatus to perform a method comprising:

accessing, using one or more processors, a first set of data from a database, the first set of data being amino acid sequences of a plurality of proteins;

comparing, using one or more processors, a second set of data to the first set of data and comparing, using one or more processors, a third set of data to the first set of data, wherein the second and third set of data are each, respectively, an amino acid sequence of the first protein of interest and an amino acid sequence of the second protein of interest, wherein a plurality of segments of the amino acid sequence of each protein of interest is individually compared to the first set of data;

generating, using one or more processors, a first profile for the first protein of interest and a second profile for the second protein of interest, wherein the first and second profile comprise, respectively, a list of all amino acid sequences from the first set of data that have segments having identical sequences to corresponding segments of the amino acid sequence of the first protein of interest, and a list of all amino acid sequences from the first set of data that have segments having identical sequences to corresponding segments of the amino acid sequence of the second protein of interest;

comparing, using one or more processors, the list of all amino acid sequences appearing in the first profile and the list of all amino acid sequences appearing in the second profile so as to determine the percent overlap between the first profile and the second profile, and storing the fourth set of data thereby produced,

wherein an at least 30% overlap of sequences between the first and the second profile indicates that the first and second proteins of interest are related proteins, while less than 30% overlap of sequences between the first and the second profile does not indicate that the first and second proteins of interest are related proteins.

### BRIEF DESCRIPTION OF THE DRAWINGS

FIGS. 1A-1B. Structure of the immunoglobulin variable (IgV) domain and its diversification in immunity. (1A) Structure of an IgV domain. Strands of the front and back sheets of the IgV domain are labeled according to convention. (1B) Representative structural and organizational variations in the Ig superfamily. Costimulatory receptors of the CD28 superfamily are predominantly disulfide-linked dimers of single IgV domains; SLAM family members contain both IgV and IgC domains; TIM family molecules contain one IgV domain attached to a highly glycosylated stalk region; nectin and nectin-like molecules consist of three Ig domains (one IgV and two IgCs).

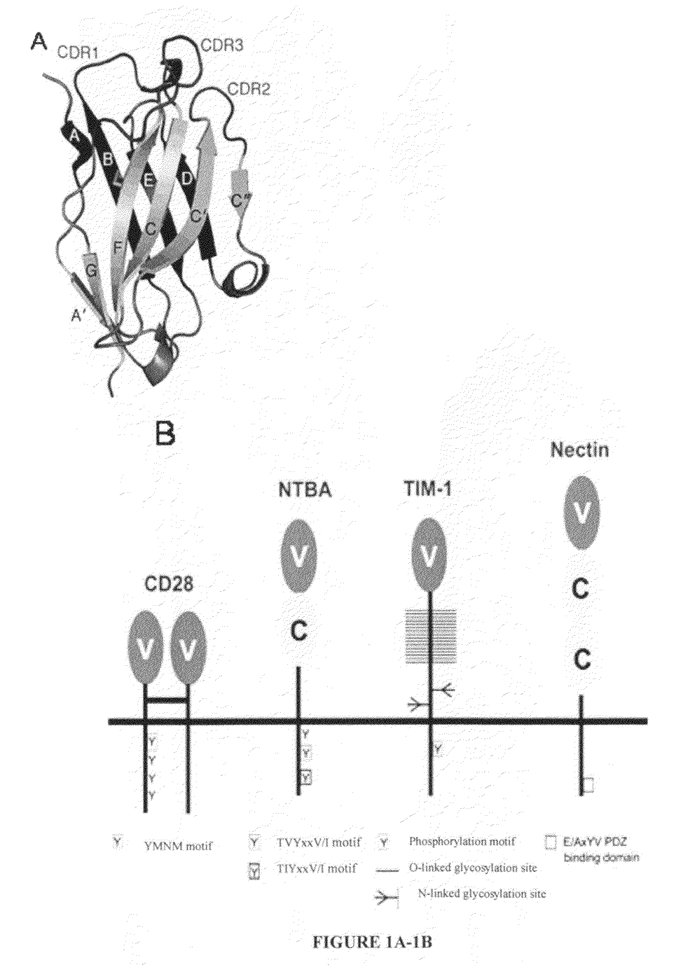

FIG. 2. Physically linked gene families. Mapping of selected Ig superfamily and all known TNF and TNFR genes on the human karyotype highlights clusters of evolutionarily related genes. Genes sharing a vertical line have immediately adjacent chromosomal positions.

FIGS. 3A-3D. Illustration of the effect of different strategies for identifying functional clusters within the human IgSF. Each member of the IgSF is represented by a circle. (3A), (3B) Clusters within the functionally related families of Nectin, SLAM, CD28, TIM, and B7/butyrophilin identified by BlastClust1 and by the clustering approach of Babbitt (3), respectively. In both cases, some functionally characterized families are not well delineated and individual family members are significantly dispersed among unrelated functional clusters. (3C) Schematic representation of BLAST-profile-based approach for identifying functionally related clusters/subfamilies. (3D) BLAST-profile-based approach provides greater discrimination and results in compact and distinct clusters of functionally related molecules. All figures prepared by Cytoscape (6).

FIG. 4. Sequence-based network graph highlighting the sequence similarities between proteins in the Nectin family. Proteins are illustrated as nodes (circles) and related sequences are connected by black lines. Homophilic interactions are denoted by grey circles; heterophilic interactions by double-headed arrows.

### DETAILED DESCRIPTION OF THE INVENTION

The present invention provides a method of determining related proteins, the method comprising obtaining sequences of interest, wherein the sequences are amino acid sequences for proteins or nucleotide sequences encoding proteins; comparing segments of each sequence of interest with a database of amino acid or nucleotide sequences; generating a profile for each sequence of interest comprising a list of all sequences from the database of sequences that have segments corresponding to the segments of each sequence of interest; and comparing the database sequences appearing in the profile of each sequence of interest to the database sequences appearing in the profile of every other sequence of interest, wherein similar profiles indicate that the sequences of interest correspond to related proteins while dissimilar profiles indicate that the sequences of interest do not correspond to related proteins, wherein profiles are similar if there is at least a 30% overlap between the database sequences appearing in the profiles of the sequences of interest.

A method of determining related proteins, the method comprising
obtaining at least a first and a second sequence of interest, wherein at least one sequence is obtained by obtaining and sequencing a sample from a subject, wherein the sequences are amino acid sequences of proteins or are nucleotide sequences encoding proteins;
individually comparing a plurality of segments of the first and second amino acid sequence of interest, or of the first and second nucleotide sequence of interest, with a database of amino acid sequences or nucleotide sequences, respectively;
generating a profile for each sequence of interest, wherein the profile comprises a list of all sequences, from the database of sequences, that have segments having identical sequences to corresponding segments of the sequence of interest; and
comparing the database sequences appearing in the profile of the first sequence of interest to the database sequences appearing in the profile of at least the second sequence of interest, wherein an at least 30% overlap of sequences between the profile of the first sequence of interest and the profile of the second sequence of interest indicates that the first and second sequences of interest are related proteins, while less than 30% overlap of sequences between the profile of the first sequence of interest and the profile of the second sequence of interest indicates that the first and second sequences of interest are not related proteins.

In an embodiment, the sequences of interest are protein amino acid sequences and the segment of each amino acid sequence of interest is at least three amino acids in length. In embodiments the segments are 3-10 amino acids, 11-50 amino acids, 51-100 amino acids, 101-500 amino acids, 501-1,000 amino acids, or 1,001-5000 amino acids, 5,001-10,000 amino acids. In an embodiment the segment is 1%, 2%, 3%, 4%, 5%, 6%, 7%, 8%, 9%, 10%, 15%, 20%, 25%, or 30% of the amino acid sequence of interest. In an embodiment the segment is from 31% to 99% of the amino acid sequence of interest. In an embodiment the whole amino acid sequence is compared. In an embodiment, the sequences of interest are nucleotide sequences and the segment of each nucleotide sequence of interest is at least 6 nucleotide bases in length. In embodiments the segments are 3-10 nucleotide bases, 11-50 nucleotide bases, 51-100 nucleotide bases, 101-500 nucleotide bases, 501-1,000 nucleotide bases, or 1,001-5000 nucleotide bases, 5,001-10,000 nucleotide bases, 10,001-20,000 nucleotide bases, 20,001-30,000 nucleotide bases. In an embodiment the segment is 1%, 2%, 3%, 4%, 5%, 6%, 7%, 8%, 9%, 10%, 15%, 20%, 25%, or 30% of the nucleotide sequence of interest. In an embodiment the segment is from 31% to 99% of the nucleotide sequence of interest. In an embodiment the whole nucleotide sequence is compared.

In an embodiment, profiles are similar if there is at least a 40% overlap between the database sequences appearing in the profiles of the sequences of interest. In an embodiment, profiles are similar if there is at least a 50% overlap between the database sequences appearing in the profiles of the sequences of interest. In an embodiment, profiles are similar if there is at least a 60% overlap between the database sequences appearing in the profiles of the sequences of interest. In an embodiment, profiles are similar if there is at least a 70% overlap between the database sequences appearing in the profiles of the sequences of interest. In an embodiment, profiles are similar if there is at least an 80% overlap between the database sequences appearing in the profiles of the sequences of interest.

In an embodiment, the database comprises at least 100, 1,000, 10,000 or 100,000 sequences. In an embodiment, the database of amino acid sequences comprises a non-redundant database. In an embodiment, the nucleotide sequences encoding proteins comprise RNA sequences. In an embodiment, the nucleotide sequences encoding proteins comprise DNA sequences. In an embodiment, comparing the sequences of interest with the database and generating a profile comprises running a Basic Local Alignment Search Tool (BLAST) series.

In an embodiment, the sequences of interest are obtained from one or more tissues from one or more subjects. In an embodiment, the tissue is blood. In an embodiment, the tissue is breast, prostate, colon, liver, pancreatic, lung, cardiac, or neural tissue. In an embodiment, the tissue is cancerous tissue. In an embodiment, the subject is a mammal. In an embodiment, the subject is a human.

A method for determining if a first protein of interest and a second protein of interest are related comprising:

accessing, using one or more processors, a first set of data from a database, the first set of data being amino acid sequences of a plurality of proteins;

comparing, using one or more processors, a second set of data to the first set of data and comparing, using one or more processors, a third set of data to the first set of data, wherein the second and third set of data are each, respectively, an amino acid sequence of the first protein of interest and an amino acid sequence of the second protein of interest, wherein a plurality of segments of the amino acid sequence of each protein of interest is individually compared to the first set of data;

generating, using one or more processors, a first profile for the first protein of interest and a second profile for the second protein of interest, wherein the first and second profile comprise, respectively, a list of all amino acid sequences from the first set of data that have segments having identical sequences to corresponding segments of the amino acid sequence of the first protein of interest, and a list of all amino acid sequences from the first set of data that have segments having identical sequences to corresponding segments of the amino acid sequence of the second protein of interest;

comparing, using one or more processors, the list of all amino acid sequences appearing in the first profile and the list of all amino acid sequences appearing in the second profile so as to determine the percent overlap between the first profile and the second profile, and storing the fourth set of data thereby produced,

wherein an at least 30% overlap of sequences between the first and the second profile indicates that the first and second proteins of interest are related proteins, while less than 30% overlap of sequences between the first and the second profile does not indicate that the first and second proteins of interest are related proteins.

A system for identifying related proteins, comprising:

one or more data processing apparatus; and

a computer-readable medium coupled to the one or more data processing apparatus having instructions stored thereon which, when executed by the one or more data processing apparatus, cause the one or more data processing apparatus to perform a method comprising:

accessing, using one or more processors, a first set of data from a database, the first set of data being amino acid sequences of a plurality of proteins;

comparing, using one or more processors, a second set of data to the first set of data and comparing, using one or more processors, a third set of data to the first set of data, wherein the second and third set of data are each, respectively, an amino acid sequence of the first protein of interest and an amino acid sequence of the second protein of interest, wherein a plurality of segments of the amino acid sequence of each protein of interest is individually compared to the first set of data;

generating, using one or more processors, a first profile for the first protein of interest and a second profile for the second protein of interest, wherein the first and second profile comprise, respectively, a list of all amino acid sequences from the first set of data that have segments having identical sequences to corresponding segments of the amino acid sequence of the first protein of interest, and a list of all amino acid sequences from the first set of data that have segments having identical sequences to corresponding segments of the amino acid sequence of the second protein of interest;

comparing, using one or more processors, the list of all amino acid sequences appearing in the first profile and the list of all amino acid sequences appearing in the second profile so as to determine the percent overlap between the first profile and the second profile, and storing the fourth set of data thereby produced,

wherein an at least 30% overlap of sequences between the first and the second profile indicates that the first and second proteins of interest are related proteins, while less than 30% overlap of sequences between the first and the second profile does not indicate that the first and second proteins of interest are related proteins.

A computer-readable medium comprising instructions stored thereon which, when executed by a data processing apparatus, causes the data processing apparatus to perform a method comprising:

accessing, using one or more processors, a first set of data from a database, the first set of data being amino acid sequences of a plurality of proteins;

comparing, using one or more processors, a second set of data to the first set of data and comparing, using one or more processors, a third set of data to the first set of data, wherein the second and third set of data are each, respectively, an amino acid sequence of the first protein of interest and an amino acid sequence of the second protein of interest, wherein a plurality of segments of the amino acid sequence of each protein of interest is individually compared to the first set of data;

generating, using one or more processors, a first profile for the first protein of interest and a second profile for the second protein of interest, wherein the first and second profile comprise, respectively, a list of all amino acid sequences from the first set of data that have segments having identical sequences to corresponding segments of the amino acid sequence of the first protein of interest, and a list of all amino acid sequences from the first set of data that have segments having identical sequences to corresponding segments of the amino acid sequence of the second protein of interest;

comparing, using one or more processors, the list of all amino acid sequences appearing in the first profile and the list of all amino acid sequences appearing in the second profile so as to determine the percent overlap between the first profile and the second profile, and storing the fourth set of data thereby produced,

wherein an at least 30% overlap of sequences between the first and the second profile indicates that the first and second proteins of interest are related proteins, while less than 30% overlap of sequences between the first and the second profile does not indicate that the first and second proteins of interest are related proteins.

In an embodiment of the method, system or computer readable medium, the segments are at least three amino acids in length. In an embodiment, an at least 40% overlap of sequences between the first and the second profile indicates that the first and second proteins of interest are related proteins. In an embodiment, an at least 50% overlap of sequences between the first and the second profile indicates that the first and second proteins of interest are related proteins. In an embodiment, an at least 60% overlap of sequences between the first and the second profile indicates that the first and second proteins of interest are related proteins. In an embodiment, an at least 70% overlap of sequences between the first and the second profile indicates that the first and second proteins of interest are related proteins. In an embodiment, an at least 80% overlap of sequences between the first and the second profile indicates that the first and second proteins of interest are related proteins. In an embodiment, the database comprises at least 100, 1,000, 10,000 or 100,000 sequences. In an embodiment, the database is a non-redundant database. In an embodiment, comparing the sequences of interest with the database and generating a profile comprises running a Basic Local Alignment Search Tool (BLAST) series.

Proteins can be related structurally and/or functionally. Proteins which are structurally related may also be functionally related. Identification of structurally or functionally related proteins produces a cohort of related proteins. Each protein in the cohort may act as an inhibitor of, or agonist of, some or all of the other proteins in the cohort. Proteins in the cohort which act as inhibitors or agonists of other proteins may be candidates for protein-based therapeutics.

A “receptor-ligand pair” as used herein is a set of two related proteins where at least one of the proteins acts as an inhibitor of, or agonist of, the other. Receptor-ligand pairs may be sought within any group of proteins, whether or not such proteins are known to be part of a protein family or protein superfamily.

Related proteins may be sought within specific a group of proteins, a protein family, a protein superfamily, the proteome, or between genomes. Various pathogens proteins may have sequences which interact with human receptors so as to enable them to function as therapeutic agents. For example, the viral proteins may be an agonist or antagonist of a human pathway. Therefore, the sequences of interest may be the primary amino acid sequence of each protein within a group of proteins, a protein family, a protein superfamily, the proteome, or between genomes. Alternatively, the sequences of interest may be the nucleotide sequence coding for each protein within a group of proteins, a protein family, a protein superfamily, or within the proteome. Looking for related proteins within the entire proteome, or even across genomes, may uncover unexpected receptor-ligand pairs.

Sequences of interest may be amino acid sequences of proteins or nucleotide sequences encoding proteins. segments of each sequence of interest are compared with a database of amino acid or nucleotide sequences, as appropriate. If the sequences of interest are amino acid sequences, the segments are at least three amino acids in length. If the sequences of interest are nucleotide sequences encoding proteins, the segments are at least six nucleotide bases in length. Database sequences that have segments corresponding to the segments from the sequence of interest are compiled into a profile for that sequence of interest. The database sequences in the profile of each sequence of interest are compared to the database sequences in the profiles of every other sequence of interest. Sequences of interest are considered to have similar profiles if at least 30% of the database sequences in their respective profiles are the same. Similar profiles indicate that the sequences of interest describe related proteins.

Any database of protein amino acid sequences or nucleotide sequences known in the art can be used. If the sequences of interest are protein sequences, the database may be any database of amino acid sequences. Preferably, if the sequences of interest are protein sequences, the database is a non-redundant database of all primary amino acid sequences. If the sequences of interest are genetic sequences which encode proteins, the database may be any database of genetic sequences which encode proteins, for example, a database of DNA or RNA sequences encoding proteins.

Any sequence alignment algorithm or sequence comparison algorithm known in the art, including but not limited to Basic Local Alignment Search Tool (BLAST), FASTA, and Smith-Waterman, may be used to prepare a profile. Preferably, a BLAST search is used to prepare a profile for each sequence of interest. A BLAST search is an algorithm which compares the sequence of interest to a database, identifying sequences in the database of sequences that resemble the sequence of interest. As used herein, the resultant list of all database sequences resembling the sequence of interest comprises the sequence of interest's “profile.”

The profile of each sequence of interest is compared pair-wise with the profile of every other sequence of interest. This all-to-all comparison comprises comparing every database sequence appearing on the profile of each sequence of interest with every database sequence appearing on the profile of every other sequence of interest. Similar profiles between, for example, two sequences of interest indicate that those two sequences of interest describe related proteins. Dissimilar profiles between sequences of interest indicate that those sequences of interest do not correspond to related proteins. Profiles are similar when there is significant overlap of database sequences between the profiles. The greater the overlap of the profiles of the sequences of interest, the more likely the corresponding proteins are related. Sequences of interest have similar profiles if at least 30% of their profiles overlap. Preferably, sequences of interest have similar profiles if at least 40% of their profiles overlap. The higher the percentage of profile overlap, the more certain it is that the sequences of interest are related. Therefore, depending on the sequences of interest and various experimental constraints, profiles may be similar if at least 50%, 60%, 70% or 80% of the database sequences appearing in the profiles of the sequences of interest overlap. Sequences corresponding to more closely related proteins are more likely to have a greater percent overlap. However, the higher the percent overlap used for a determination of similarity, the higher the likelihood of false negatives. Sequences corresponding to more distantly related proteins are more likely to have a lower percent overlap. However, the lower the percent overlap used for a determination of similarity, the higher the likelihood of determining sequences corresponding to proteins to be related when they are not.

The sequences of interest may be obtained from one or more tissues from one or more subjects. The tissue may be any tissue, including but not limited to, blood, breast, prostate, colon, liver, pancreatic, lung, cardiac, or neural tissue. Additionally, the tissue may be cancerous. The subject may be an animal, plant, bacteria, or virus. Preferably, the subject is an animal. More preferably, the subject is a mammal such as a human or a rodent.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer readable medium for execution by, or to control the operation of, data processing apparatus. The computer readable medium can be a machine readable storage device, a machine readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

This invention will be better understood from the Experimental Details, which follow. However, one skilled in the art will readily appreciate that the specific methods and results discussed are merely illustrative of the invention as described more fully in the claims that follow thereafter.

### Experimental Details

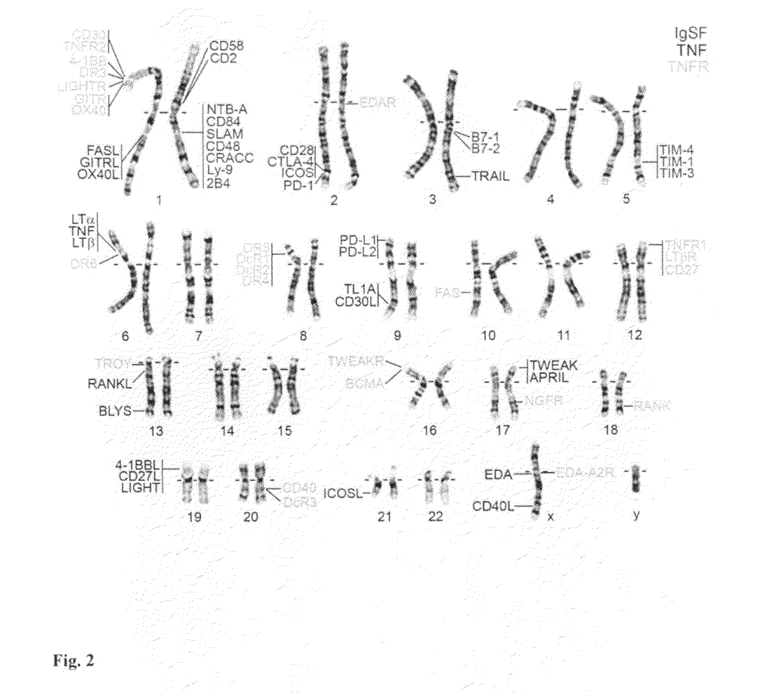

The present invention can represent a significant improvement in large divergent superfamilies, such as the Ig superfamily, where sequence identities can be lower than 15%. A representative example is provided by the nectin and nectin-like family of Ig-containing proteins that mediate both homophilic and heterophilic cell-cell adhesion interactions. The family is composed of nectin-1-4 (PVRL1-PVRL4) and nectin-like-1-5 (also called CADM1-CADM4 and PVR) (FIG. 2). The sequence-based clustering methods of the present invention also identified five additional Ig-containing molecules, CD226, CRTAM (class I MHC-restricted T-cell associated molecule), CD96, VSTM3, also known as TIGIT (T-cell immunoreceptor with Ig and immunoreceptor tyrosine-based inhibition motif (ITIM)), and CD200, as members of this family. In this family, only two genes (CD96 and PVRL3) are adjacent in the genome. The genes in this cluster also demonstrate similarities in both domain organization (specifically between nectin and nectin-like) and function. With the exception of CD200, the ligands for all these molecules reside within this same family (7, 8). Taken together, these observations support the hypothesis that these molecules all form a single sequence-based cluster or family within the Ig superfamily. Notably, the structure of only a single family member, nectin-like-1, has been determined to atomic resolution to date (9). Because nectin-like-1 shares less than 30% sequence identity with most members of the family, structures of additional family members are likely to reveal shared structural features common to the entire family, as well as unique features related to functional diversity. Thus, comprehensive sequence considerations not only allow for an expanded description of protein families, but also highlight those families where additional structure determination efforts are warranted.

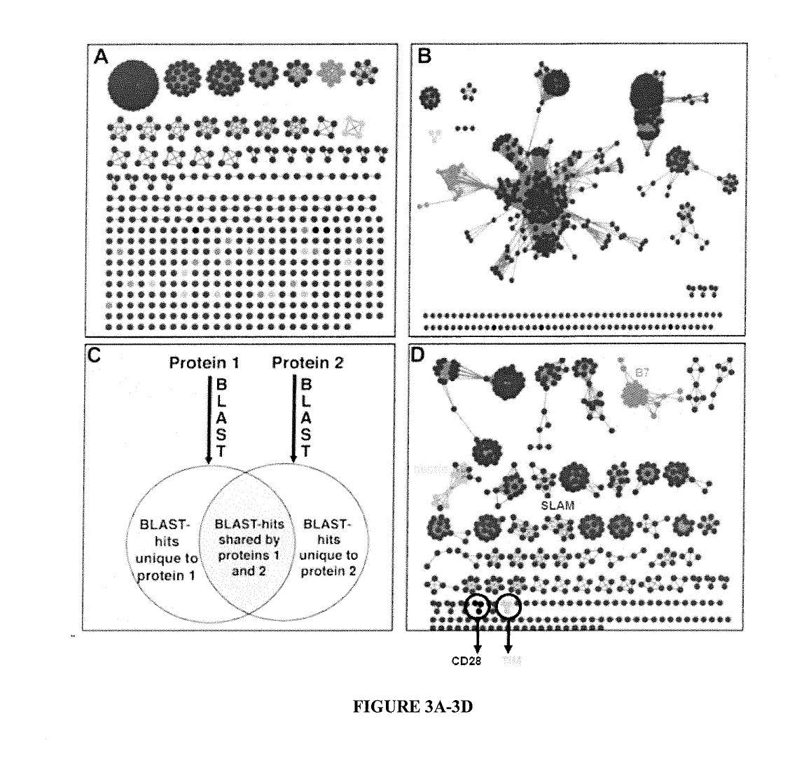

While gene proximity is tremendously useful, not all related sequences are physically linked, but are widely distributed across the genome. Thus, more general approaches to define related families of proteins solely on the basis primary amino acid sequences must be employed. In large divergent superfamilies, such as the Ig superfamily where sequence identities can be lower than 15%, this represents a significant challenge. The present algorithm defines a ‘profile’ for each individual primary sequence. Sequences that share similar profiles are assigned to the same sequence family. The present invention was illustrated for the approximately 600 proteins in the human genome that are predicted with high confidence to encode secreted or cell surface proteins that contain Ig domains. For each of the 600 query proteins a BLAST (2) search was performed against the non-redundant (NR) database. Sequence profiles were defined for each query as the list of significant BLAST hits (i.e., e-value lower than 0.001, and with minimum hit-query alignment coverage of 30%). After an all-to-all comparison of the query profiles (i.e., lists), proteins were deemed to be related if their BLAST profiles overlapped by more than 45% (the results were relatively insensitive to changing this parameter). The overlap was defined as the ratio of the number of equivalent significant hits (e.g. greater than 90%, 91%, 92%, 93%, 94%, 95%, 96%, 97%, 98% or 99% identity) found in both profiles, normalized to the size of the smaller of the two compared profiles (if the profiles are of different sizes). This approach compares the groups of related sequences instead of pairs of sequences. By averaging the signal from a group of sequences, the signal to noise ratio was improved and can thus define functionally related groups of proteins more readily than simply considering direct pair wise comparisons. FIG. 3 demonstrates that the approach of the present invention recognizes and clusters functional groups much more accurately than other available approaches. Specifically, the present invention results in compact and distinct clusters for the SLAM, nectin, C28 and B7 families, whereas the pair wise-based approaches result in less well delineated associations and individual family members are significantly dispersed among unrelated functional clusters.

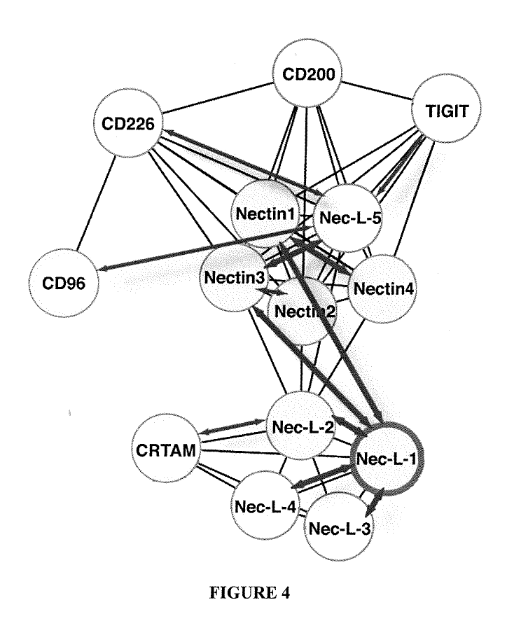

A representative example is provided by the nectin and nectin-like family of Ig-containing proteins that mediate both homophilic and heterophilic cell-cell adhesion interactions. The family is composed of nectin-like-1-4 and nectin-like-1-5 (FIG. 4). The profile-based clustering method also identified five additional Ig-containing molecules, CD226, CRTAM (class I MHC-restricted T-cell associated molecule), CD96, CD200 and TIGIT (T-cell immunoreceptor with Ig and immunoreceptor tyrosine-based inhibition motif (ITIM)) as members of this family. These five proteins had not been associated previously with this family on the basis of sequence considerations. Notably, at the time of this analysis, TIGIT had no known functional annotation. Analysis by the presently applied algorithm linked this protein to the nectin-like family, suggesting that it interacted with at least one of the nectin-like family members. This hypothesis was subsequently validated by a publication from Genentech, which screened a library of ˜1000 purified cell surface proteins and found that only Nectin-like-5 bound to TIGIT (4, 5). Remarkably, with the exception of CD200, the ligands for all these molecules reside within this same family (4, 5) (FIG. 4). Taken together, these observations support the hypothesis that these molecules all form a single functional subfamily within the Ig superfamily. This relationship immediately leads to the hypothesis that CD200 also contains a binding partner in this cluster.

### REFERENCES

1. Altschul, S. F. et al., Gapped BLAST and PSI-BLAST: a new generation of protein database search programs. Nucleic Acids Res 25 (17), 3389-3402 (1997).
2. Schaffer, A. A. et al., Improving the accuracy of PSI-BLAST protein database searches with composition-based statistics and other refinements. Nucleic Acids Res. 29 (14), 2994 (2001).
3. Atkinson, H. J., Morris, J. H., Ferrin, T. E., & Babbitt, P. C., Using sequence similarity networks for visualization of relationships across diverse protein superfamilies. PLoS One 4 (2), e4345 (2009).
4. Takai, Y., Miyoshi, J., Ikeda, W., & Ogita, H., Nectins and nectin-like molecules: roles in contact inhibition of cell movement and proliferation. Nat Rev Mol Cell Biol 9 (8), 603-615 (2008).
5. Yu, X. et al., The surface protein TIGIT suppresses T cell activation by promoting the generation of mature immunoregulatory dendritic cells. Nat Immunol 10 (1), 48-57 (2009).
6. Shannon, P. et al., Cytoscape: a software environment for integrated models of biomolecular interaction networks. Genome Res 13 (11), 2498-2504 (2003).
7. Takai Y, Miyoshi J, Ikeda W, Ogita H. Nectins and nectin-like molecules: roles in contact inhibition of cell movement and proliferation. Nat Rev Mol Cell Biol 2008; 9:603-615.
8. Yu X, et al. The surface protein TIGIT suppresses T cell activation by promoting the generation of mature immunoregulatory dendritic cells. Nat Immunol 2009; 10: 48-57.
9. Dong X, et al. Crystal structure of the V domain of human Nectin-like molecule-1/Syncam3/Tsll1/Igsf4b, a neural tissue specific immunoglobulin-like cell-cell adhesion molecule. J Biol Chem 2006; 281:10610-10617.

1. A method of determining related proteins, the method comprising
obtaining at least a first and a second sequence of interest, wherein at least one sequence is obtained by obtaining and sequencing a sample from a subject, wherein the sequences are amino acid sequences of proteins or are nucleotide sequences encoding proteins;
individually comparing a plurality of segments of the first and second amino acid sequence of interest, or of the first and second nucleotide sequence of interest, with a database of amino acid sequences or nucleotide sequences, respectively;
generating a profile for each sequence of interest, wherein the profile comprises a list of all sequences, from the database of sequences, that have segments having identical sequences to corresponding segments of the sequence of interest; and
comparing the database sequences appearing in the profile of the first sequence of interest to the database sequences appearing in the profile of at least the second sequence of interest, wherein an at least 30% overlap of sequences between the profile of the first sequence of interest and the profile of the second sequence of interest indicates that the first and second sequences of interest are related proteins, while less than 30% overlap of sequences between the profile of the first sequence of interest and the profile of the second sequence of interest indicates that the first and second sequences of interest are not related proteins.

2. The method of claim 1, wherein the sequences of interest are protein amino acid sequences and the plurality of segments of each amino acid sequence of interest are at least three amino acids in length.

3. The method of claim 1, wherein the sequences of interest are nucleotide sequences and the plurality of segments of each nucleotide sequence of interest are at least 6 nucleotide bases in length.

4. The method of claim 1, wherein profiles are similar if there is at least a 40% overlap between the database sequences appearing in the profiles of the sequences of interest.

5. The method of claim 1, wherein profiles are similar if there is at least a 50% overlap between the database sequences appearing in the profiles of the sequences of interest.

6. The method of claim 1, wherein profiles are similar if there is at least a 60% overlap between the database sequences appearing in the profiles of the sequences of interest.

7. The method of claim 1, wherein profiles are similar if there is at least a 70% overlap between the database sequences appearing in the profiles of the sequences of interest.

8. The method of claim 1, wherein profiles are similar if there is at least a 80% overlap between the database sequences appearing in the profiles of the sequences of interest.

9. The method of claim 1, wherein the database comprises at least 100, 1,000, 10,000 or 100,000 sequences.

10. The method of claim 1, wherein the database of amino acid sequences comprises a non-redundant database.

11. The method of claim 3, wherein the nucleotide sequences encoding proteins comprise RNA sequences.

12. The method of claim 3, wherein the nucleotide sequences encoding proteins comprise DNA sequences.

13. The method of claim 1, wherein comparing the sequences of interest with the database and generating a profile comprises running a Basic Local Alignment Search Tool (BLAST) series.

14. The method of claim 1, wherein the sequences of interest are obtained from one or more tissues from one or more subjects.

15. The method of claim 14, wherein the tissue is blood.

16. The method of claim 14, wherein the tissue is breast, prostate, colon, liver, pancreatic, lung, cardiac, or neural tissue.

17. The method of claim 14, wherein the tissue is cancerous tissue.

18-19. (canceled)

20. A method for determining if a first protein of interest and a second protein of interest are related comprising:
accessing, using one or more processors, a first set of data from a database, the first set of data being amino acid sequences of a plurality of proteins;
comparing, using one or more processors, a second set of data to the first set of data and comparing, using one or more processors, a third set of data to the first set of data, wherein the second and third set of data are each, respectively, an amino acid sequence of the first protein of interest and an amino acid sequence of the second protein of interest, wherein a plurality of segments of the amino acid sequence of each protein of interest is individually compared to the first set of data;
generating, using one or more processors, a first profile for the first protein of interest and a second profile for the second protein of interest, wherein the first and second profile comprise, respectively, a list of all amino acid sequences from the first set of data that have segments having identical sequences to corresponding segments of the amino acid sequence of the first protein of interest, and a list of all amino acid sequences from the first set of data that have segments having identical sequences to corresponding segments of the amino acid sequence of the second protein of interest;
comparing, using one or more processors, the list of all amino acid sequences appearing in the first profile and the list of all amino acid sequences appearing in the second profile so as to determine the percent overlap between the first profile and the second profile, and storing the fourth set of data thereby produced,
wherein an at least 30% overlap of sequences between the first and the second profile indicates that the first and second proteins of interest are related proteins, while less than 30% overlap of sequences between the first and the second profile does not indicate that the first and second proteins of interest are related proteins.

21. A system for identifying related proteins, comprising:
one or more data processing apparatus; and
a computer-readable medium coupled to the one or more data processing apparatus having instructions stored thereon which, when executed by the one or more data processing apparatus, cause the one or more data processing apparatus to perform a method comprising:
accessing, using one or more processors, a first set of data from a database, the first set of data being amino acid sequences of a plurality of proteins;
comparing, using one or more processors, a second set of data to the first set of data and comparing, using one or more processors, a third set of data to the first set of data, wherein the second and third set of data are each, respectively, an amino acid sequence of the first protein of interest and an amino acid sequence of the second protein of interest, wherein a plurality of segments of the amino acid sequence of each protein of interest is individually compared to the first set of data;
generating, using one or more processors, a first profile for the first protein of interest and a second profile for the second protein of interest, wherein the first and second profile comprise, respectively, a list of all amino acid sequences from the first set of data that have segments having identical sequences to corresponding segments of the amino acid sequence of the first protein of interest, and a list of all amino acid sequences from the first set of data that have segments having identical sequences to corresponding segments of the amino acid sequence of the second protein of interest;
comparing, using one or more processors, the list of all amino acid sequences appearing in the first profile and the list of all amino acid sequences appearing in the second profile so as to determine the percent overlap between the first profile and the second profile, and storing the fourth set of data thereby produced,
wherein an at least 30% overlap of sequences between the first and the second profile indicates that the first and second proteins of interest are related proteins, while less than 30% overlap of sequences between the first and the second profile does not indicate that the first and second proteins of interest are related proteins.

22. A computer-readable medium comprising instructions stored thereon which, when executed by a data processing apparatus, causes the data processing apparatus to perform a method comprising:
accessing, using one or more processors, a first set of data from a database, the first set of data being amino acid sequences of a plurality of proteins;
comparing, using one or more processors, a second set of data to the first set of data and comparing, using one or more processors, a third set of data to the first set of data, wherein the second and third set of data are each, respectively, an amino acid sequence of the first protein of interest and an amino acid sequence of the second protein of interest, wherein a plurality of segments of the amino acid sequence of each protein of interest is individually compared to the first set of data;
generating, using one or more processors, a first profile for the first protein of interest and a second profile for the second protein of interest, wherein the first and second profile comprise, respectively, a list of all amino acid sequences from the first set of data that have segments having identical sequences to corresponding segments of the amino acid sequence of the first protein of interest, and a list of all amino acid sequences from the first set of data that have segments having identical sequences to corresponding segments of the amino acid sequence of the second protein of interest;
comparing, using one or more processors, the list of all amino acid sequences appearing in the first profile and the list of all amino acid sequences appearing in the second profile so as to determine the percent overlap between the first profile and the second profile, and storing the fourth set of data thereby produced,
wherein an at least 30% overlap of sequences between the first and the second profile indicates that the first and second proteins of interest are related proteins, while less than 30% overlap of sequences between the first and the second profile does not indicate that the first and second proteins of interest are related proteins.

23-32. (canceled)
